(19) United States
(12) Patent Application Publication
(10) Pub. No.: US 2026/0138341 A1
(43) Pub. Date: May 21, 2026

(54) REPAIR METHOD

(71) Applicant: TOYOTA JIDOSHA KABUSHIKI KAISHA, Toyota-shi (JP)

(72) Inventor: Tetsuya KUROSAKA, Toyota-shi (JP)

(73) Assignee: TOYOTA JIDOSHA KABUSHIKI KAISHA, Toyota-shi (JP)

(21) Appl. No.: 19/310,172

(22) Filed: Aug. 26, 2025

(30) Foreign Application Priority Data
Nov. 15, 2024 (JP) 2024-199639

(51) Int. Cl. B29C 73/02; B29L 31/00; B29L 31/26; F16J 15/14

(52) U.S. Cl. CPC B29C 73/02; F16J 15/14; B29L 2031/265; B29L 2031/749

(57) ABSTRACT

A repair method is for repairing oil leakage from a joint portion that is a portion where members are joined to each other by a liquid gasket, in a device where the members are joined to each other by the liquid gasket. The repair method includes: applying a coloring agent of a color different from a color of a coating surface to a portion of a surface portion of the device surrounding an oil leakage location at the joint portion; scraping off the coating surface to which the coloring agent is applied together with the coloring agent until the coloring agent is not left; and applying a repair agent capable of being adhered to both the liquid gasket joining the members to each other and the members to a portion from which the coloring agent is scraped off to cover the oil leakage location.

### CROSS-REFERENCE TO RELATED APPLICATION

This application claims priority to Japanese Patent Application No. 2024-199639 filed on Nov. 15, 2024. The disclosure of the above-identified application, including the specification, drawings, and claims, is incorporated by reference herein in its entirety.

### BACKGROUND

### 1. Technical Field

The present disclosure relates to a repair method.

### 2. Description of Related Art

Japanese Unexamined Patent Application Publication No. 2010-144645 (JP 2010-144645 A) discloses a device in which members are joined to each other by using a formed-in-place gasket (FIPG) that is a liquid gasket. Specifically, a method of disassembling the device into a unit of member, applying a new FIPG, and then reassembling the device is disclosed.

### SUMMARY

In a case where the oil leakage occurs from a joint portion using the FIPG, as described in JP 2010-144645 A, when the device is disassembled once, the new FIPG is applied, and then the reassembly is performed, the work takes time.

A repair method for solving the problem described above is a repair method for repairing, in a device in which multiple members are joined to each other by a liquid gasket, oil leakage from a joint portion that is a portion where the members are joined to each other by the liquid gasket.

The repair method includes applying a coloring agent of a color different from a color of a coating surface to a portion of a surface portion of the device that is surrounding an oil leakage location at the joint portion.
The repair method includes scraping off the coating surface to which the coloring agent is applied, together with the coloring agent until the coloring agent is not left.
The repair method includes applying a repair agent that is adherable to both the liquid gasket joining the members to each other and the members to a portion from which the coloring agent is scraped off to cover the oil leakage location.

With the repair method described above, the oil leakage can be repaired without disassembling of the device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a location where oil leakage occurs in an engine;

FIG. 2 is a diagram showing an aspect of the engine shown in FIG. 1 when viewed from another direction;

FIG. 3 is a flowchart showing a procedure of a repair method of an embodiment;

FIG. 4 is a schematic diagram showing a range of a surface portion of the engine to be subjected to the processing in the repair method of the embodiment;

FIG. 5 is a schematic diagram showing an aspect in which the engine is coated with a repair agent in the repair method of the embodiment; and

FIG. 6 is a schematic diagram showing an example of a device to which a repair method of a modification can be applied.

### DETAILED DESCRIPTION OF EMBODIMENTS

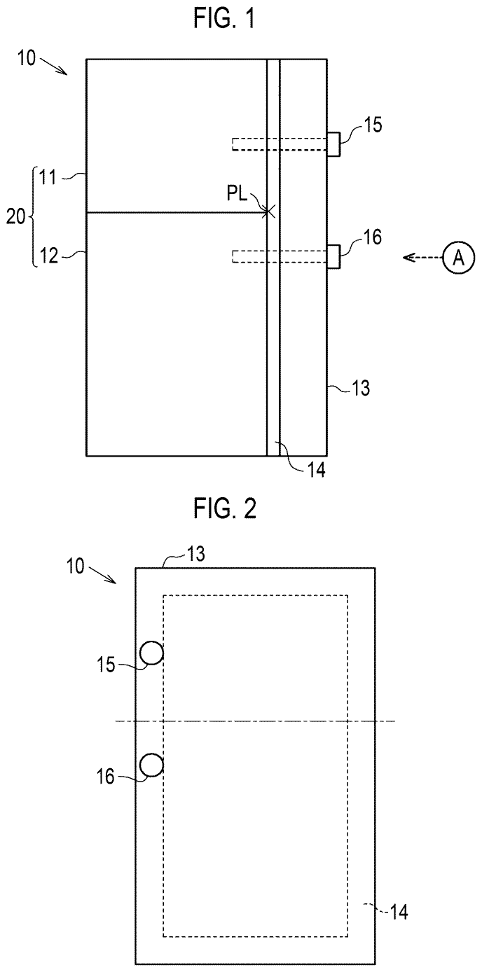

Hereinafter, an embodiment of a repair method will be described with reference to FIGS. 1 to 5.

### Configuration of Engine 10

As shown in FIG. 1, in an engine 10, a cylinder head 11 is attached to a cylinder block 12. Hereinafter, a member in which the cylinder head 11 and the cylinder block 12 are combined is referred to as an engine body 20 in the engine 10.

As shown in FIG. 1, a chain cover 13 is attached to an end portion of the engine body 20. The engine body 20 and the chain cover 13 are joined to each other by the liquid gasket 14. The liquid gasket 14 is a formed-in-place gasket (FIPG).

As shown in FIG. 1, the chain cover 13 is fastened to an end surface of the engine body 20 by a plurality of bolts. A first bolt 15 fastens the chain cover 13 to an end surface of the cylinder head 11 in the engine body 20. A second bolt 16 fastens the chain cover 13 to an end surface of the cylinder block 12 in the engine body 20.

FIG. 2 shows an aspect when the engine 10 is viewed from the position of A shown in FIG. 1 in the direction of the dotted arrow in FIG. 1. The chain cover 13 is joined to the cylinder head 11 with a one-dot chain line at the upper portion in FIG. 2. The chain cover 13 is joined to the cylinder block 12 with a one-dot chain line at the lower portion in FIG. 2.

As shown in FIG. 1, the liquid gasket 14 is adhered to a joint portion that is a portion where the engine body 20 and the chain cover 13 are joined to each other. The portion outside the broken line in FIG. 2 is a portion where the liquid gasket 14 is interposed between the engine body 20 and the chain cover 13. As shown in FIG. 2, the liquid gasket 14 is adhered to a portion of the edge of the chain cover 13. The first bolt 15 and the second bolt 16 are fastened to the engine body 20 and the chain cover 13 such that the liquid gasket 14 is penetrated.

As described above, the engine 10 is a device in which a plurality of members is joined using the cylinder head 11, the cylinder block 12, and the chain cover 13 as the members via the liquid gasket 14.

In a case where the cleaning of the location to which the liquid gasket 14 is applied is insufficient, the liquid gasket 14 may not be sufficiently adhered to the member and oil leakage may occur from the joint portion between the members. In FIG. 1, a point PL indicated by a cross mark shows an example of a position of an oil leakage location.

When the engine 10 is operated from the cold state, the cylinder head 11 is first easily expanded by heat. Since a surface pressure is sufficiently applied to a portion fastened by the bolts at the joint portion between the cylinder head 11 and the chain cover 13 and the joint portion between the cylinder block 12 and the chain cover 13, oil leakage is less likely to occur. On the other hand, the portion between the bolts at the joint portion has a lower surface pressure than the portion fastened by the bolts. Therefore, since in a portion between the first bolt 15 and the second bolt 16 at the joint portion, such as the point PL shown in FIG. 1, the liquid gasket 14 is stretched by the expansion of the cylinder head 11, the oil leakage is likely to occur.

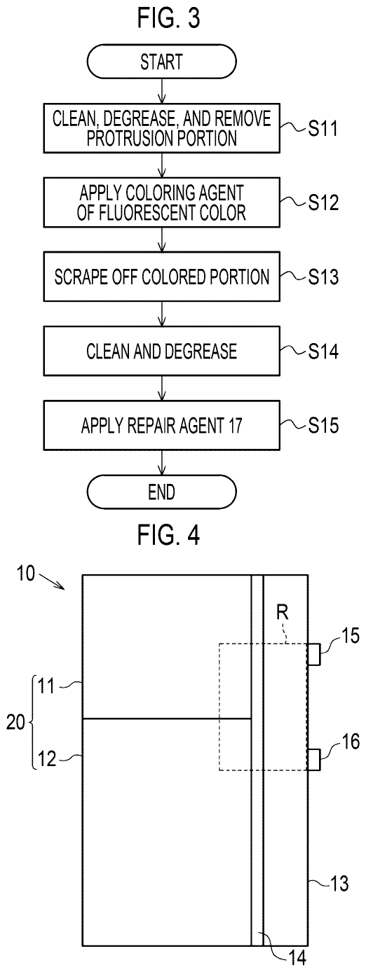

FIG. 3 shows a procedure of work for repairing the oil leakage from the joint portion in the engine 10. Hereinafter, a work procedure of the repair method for the oil leakage will be described with reference to FIGS. 3 to 5.

### Procedure of Repair Method

As shown in FIG. 3, in a case of repairing the oil leakage, the worker first cleans and degreases a portion of the surface portion of the engine 10 around the oil leakage location in the work of S11. At a stage where the series of works shown in FIG. 3 is started, the liquid gasket 14 may be deformed and protrude from the joint portion to the outside of the engine 10. In the work of S11, the worker removes a protrusion portion that is a portion of the liquid gasket 14 protruding from the engine 10 in a case where the liquid gasket 14 is protruded from the joint portion to the outside of the engine 10.

FIG. 4 shows a range R that is a portion of the surface portion of the engine 10 on which the processing is performed in the repair method shown in FIG. 3. The range R is set in a portion that surrounds the oil leakage location in the joint portion such that an entirety of the oil leakage location is included. As shown in FIG. 4, the range R is set to include an entirety of the joint portion positioned between the first bolt 15 and the second bolt 16.

In the work of S11, the worker cleans and degreases the portion of the surface portion of the engine 10 in the range R. In addition, in the work of S11, the worker removes the protrusion portion in a case where the liquid gasket 14 protrudes in the range R.

The worker who performed the work of S11 next performs the work of S12. In the work of S12, the worker applies the coloring agent to the portion of the engine 10 in the range R. At this time, the worker uses a paint of a fluorescent color having a color different from the color of the surface portion of the engine 10 that is the coating surface and the liquid gasket 14, as the coloring agent. For example, in the work of S12, the worker colors the portion in the range R using a marker pen.

The worker who performed the work of S12 next performs the work of S13. In the work of S13, the worker scrapes off the portion of the surface portion of the engine 10 in the range R colored in the work of S12. At this time, the worker scrapes off the coating surface to which the coloring agent is applied together with the coloring agent until the coloring agent is not left. The worker performs the work of S13 using, for example, a router.

The worker who performed the work of S13 next performs the work of S14. In the work of S14, the worker cleans and degreases the portion in the range R that is scraped off in S13.

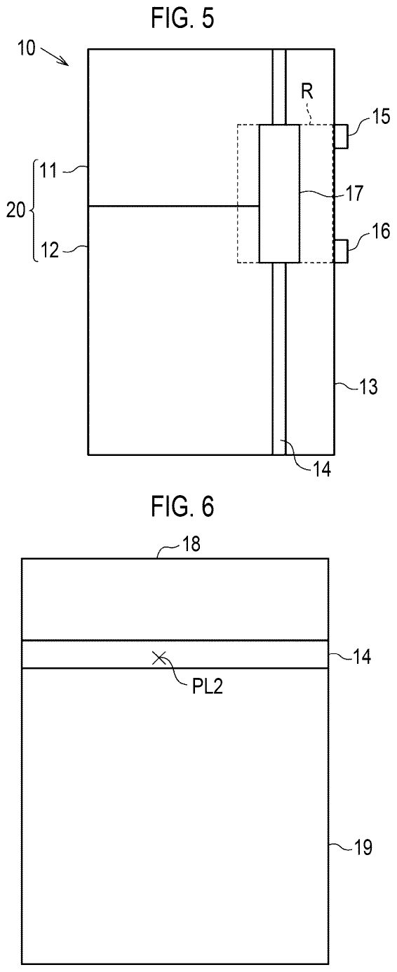

The worker who performed the work of S14 next performs the work of S15. In the work of S15, the worker applies a repair agent 17 to the engine 10. FIG. 5 shows an aspect in which the engine 10 is coated with the repair agent 17.

The repair agent 17 can be adhered to both the liquid gasket 14 that joins the members to each other in the engine 10 and the member in the engine 10. For example, the repair agent 17 is the liquid gasket 14 having properties that can be adhered to the liquid gasket 14 that has already been adhered to the engine 10 and joins the members to each other.

In FIG. 5, the repair agent 17 is applied along the joint portion within the range R. In the work of S15, the worker applies the repair agent 17 to the portion from which the coloring agent is scraped off to cover the oil leakage location.

The surface portion of the engine 10 in which the oil leakage has occurred may be provided with an adhesive hindrance layer. The adhesive hindrance layer is formed, for example, by a mold release agent used when the member is molded by die casting.

The repair agent 17 may be fixed to the surface of the member by being bonded to a hydroxyl group on the surface of the member. In a case where the surface of the member is covered with the adhesive hindrance layer, the repair agent 17 cannot be fixed by being bonded to the hydroxyl group. As described above, the adhesive hindrance layer is a layer that hinders the adhesion of the repair agent 17 to the member.

In the repair method shown in FIG. 3, the location to which the repair agent 17 is adhered is colored in the work of S12, and then the adhesive hindrance layer on the surface of the member is removed by scraping off the colored portion in the work of S13. As a result, the repair agent 17 applied in the work of S15 can be fixed to the surface of the engine 10.

In the work of S15, the worker applies the repair agent 17 to the engine 10, whereby the series of work shown in FIG. 3 is completed. The repair agent 17 fixed to the surface of the engine 10 block the oil leakage location, so that the oil leakage is repaired.

### Operation of Present Embodiment

The surface of the member may be provided with the adhesive hindrance layer that hinders the adhesion of the repair agent 17 to the member. In this case, even in a case where the repair agent 17 is applied to the oil leakage location to block the oil leakage location, the repair agent 17 cannot be fixed to the oil leakage location.

In the repair method, the adhesive hindrance layer is removed, and then the repair agent 17 is applied to block the oil leakage location. As a result, the repair agent 17 is fixed to the oil leakage location.

### Effect of Present Embodiment

(1) In the repair method, the oil leakage can be stopped by applying the repair agent 17 to the oil leakage location. As a result, in the repair method, the oil leakage can be repaired without disassembling the device.
(2) In the engine 10, the oil leakage location may be positioned in the joint portion positioned between the first bolt 15 and the second bolt 16. In this case, in the repair method, the coloring agent is applied to the range including the entirety of the joint portion positioned between the first bolt 15 and the second bolt 16. In the engine 10, the chain cover 13 is attached to the end portion of the engine body 20 in which the cylinder head 11 is attached to the cylinder block 12 via the liquid gasket 14.

When the portion to be colored is set to be narrow, the location to which the repair agent 17 is adhered may be insufficiently subjected to processing. In the repair method, in a case where the oil leakage occurs between the first bolt 15 and the second bolt 16, the colored location is decided to include the entirety of the joint portion positioned between the locations fastened by the bolts. As a result, in the repair method, the range in which the oil leakage location can be reliably covered can be set as the colored portion. In addition, according to the repair method, since the colored location is set with the position of the bolt as a mark, the range can be easily set for the worker.
(3) In the repair method, the paint of the fluorescent color is used as the coloring agent. There is also a case where the oil leakage is repaired in a state where the device is in a dim location, such as a case where the work is performed in a state where the device is mounted on the vehicle. Therefore, it is desirable that the coloring agent is a color in which the portion to be colored is easily visible. In the repair method, the member is coated with the paint of the fluorescent color. As a result, in the repair method, the worker can easily notice the location to be scraped off.
(4) The repair method includes cleaning and degreasing a portion to which the coloring agent is to be applied before the coloring agent is applied (S11). The repair method includes cleaning and degreasing the portion from which the coloring agent is scraped off after the portion to which the coloring agent is applied is scraped off (S14).

In a case where the member is stained with mud or oil, the coloring agent is difficult to be adhered. In addition, in a case where the coloring agent is scraped off, the portion from which the coloring agent is scraped off may be attached with scraped chips. In this case, the repair agent 17 is less likely to be adhered to the portion after being scraped off.

In the repair method, the portion to be subjected to the processing is cleaned and degreased before coloring and after the portion that is colored is scraped off. As a result, in the repair method, the coloring agent and the repair agent 17 can be easily adhered to each other.

### Modification

The embodiment described above can be modified and carried out as follows. The embodiment described above and the following modification can be carried out in combination within a technically consistent range.

In the example, the oil leakage occurred at the joint portion positioned between the first bolt 15 and the second bolt 16 in the engine 10 is repaired. The repair method can also be applied to other locations.

The repair method can be applied as long as the oil leakage occurs at the joint portion in the engine 10, even when the oil leakage location is not positioned between the first bolt 15 and the second bolt 16.

The repair method can be applied to devices other than the engine 10. FIG. 6 shows an example of a device to which the repair method of the modification can be applied. The device shown in FIG. 6 includes a first member 18 and a second member 19 as members. The first member 18 and the second member 19 are joined to each other by the liquid gasket 14.

In FIG. 6, a point PL2 indicated by a cross mark shows an example of the position of the oil leakage location. The repair method can be applied to a device in which members are joined to each other by the liquid gasket 14 as shown in FIG. 6, in a case where the oil leakage occurs from the joint portion. For example, the repair method can be applied to a transmission in which the members are joined to each other via the liquid gasket 14.

The repair method includes performing the processing on the portion in the range R that is a range including the entirety of the joint portion positioned between the first bolt 15 and the second bolt 16. The range subjected to the processing in the repair method is not limited to the aspect of the range R. For example, the range subjected to the processing in the repair method may be a range including a part of the joint portion positioned between the first bolt 15 and the second bolt 16.

In the repair method, the paint of the fluorescent color may not be used as the coloring agent.

The repair method may not include cleaning and degreasing a portion to which the coloring agent is to be applied before the coloring agent is applied. The repair method may not include cleaning and degreasing the portion from which the coloring agent is scraped off after the portion to which the coloring agent is applied is scraped off.

1. A repair method for repairing, in a device in which multiple members are joined to each other by a liquid gasket, oil leakage from a joint portion that is a portion where the members are joined to each other by the liquid gasket, the repair method comprising:
applying a coloring agent of a color different from a color of a coating surface to a portion of a surface portion of the device that is surrounding an oil leakage location at the joint portion;
scraping off the coating surface to which the coloring agent is applied, together with the coloring agent until the coloring agent is not left; and
applying a repair agent that is adherable to both the liquid gasket joining the members to each other and the members to a portion from which the coloring agent is scraped off to cover the oil leakage location.

2. The repair method according to claim 1, wherein, in an engine in which a chain cover is attached to an end portion of an engine body in which a cylinder head is attached to a cylinder block, via the liquid gasket, in a case where the oil leakage location is positioned in the joint portion positioned between a first bolt that fastens the chain cover to an end surface of the cylinder head in the engine body and a second bolt that fastens the chain cover to an end surface of the cylinder block in the engine body, the coloring agent is applied to an area including an entirety of the joint portion positioned between the first bolt and the second bolt.

3. The repair method according to claim 1, wherein a paint of a fluorescent color is used as the coloring agent.

4. The repair method according to claim 1, further comprising:
cleaning and degreasing a portion to which the coloring agent is to be applied before the coloring agent is applied; and
after a portion to which the coloring agent is applied is scraped off, cleaning and degreasing a portion from which the coloring agent is scraped off.
